(19) United States
(12) Patent Application Publication
(10) Pub. No.: US 2016/0143029 A1
(43) Pub. Date: May 19, 2016

(54) BASE STATION DEVICE, TERMINAL DEVICE, AND COMMUNICATION METHOD

(71) Applicant: SHARP KABUSHIKI KAISHA, Osaka (JP)

(72) Inventors: Jungo GOTO, Osaka-shi (JP); Osamu NAKAMURA, Osaka-shi (JP); Yasuhiro HAMAGUCHI, Osaka-shi (JP)

(21) Appl. No.: 14/900,793

(22) PCT Filed: Jun. 18, 2014
(86) PCT No.: PCT/JP2014/066189

§ 371 Date: Dec. 22, 2015

(30) Foreign Application Priority Data
Jun. 27, 2013 (JP) 2013-134652

(51) Int. Cl. H04W 72/04; H04L 5/00

(52) U.S. Cl. CPC H04W 72/0446; H04L 5/0094

(57) ABSTRACT

A base station device is able to allocate the resources of multiple subframes to a terminal device by MSS, and thereby improve frame utilization efficiency. However, there is a problem in that the terminal device must attempt to detect control information every frame, leading to higher power consumption of the terminal device. Provided is a base station device that transmits a signal made of a frame made up of a plurality of subframes, the base station device including a PDCCH generation unit that at least generates data for indicating a resource allocation to a terminal device, and a PDSCH generation unit that at least generates data for indicating data of a higher layer, wherein the data for indicating a resource allocation at least includes data related to a number of subframes for allocating a resource of a plurality of subframes, and the data of a higher layer includes information related to a periodicity at which the data for allocating a resource of a plurality of subframes is transmitted.

### TECHNICAL FIELD

The present invention relates to a base station device, a terminal device, and a communication method.

### BACKGROUND ART

Standardization of the Long Term Evolution (LTE) system (Rel. 8 and Rel. 9) which is a 3.9G wireless communication system for mobile phones is complete, and the LTE-Advanced (LTE-A; also called IMT-A and the like) system (Rel. 10 and up) that further advances the LTE system currently is being standardized as one of the 4G wireless communication systems.

In Rel. 12 of the LTE-A system, scenarios of densely arranged pico base station devices with small cell coverage (pico eNB; also called evolved Node B, SmallCell, low power node, and the like) are being investigated. Also expected are situations in which a terminal device (user device, UE, mobile station device) that connects to a pico base station device has a slow movement speed or a small delay spread. For this reason, frequency and time variation in the channel of the terminal device that connects to the pico base station device is expected to be small.

In LTE, the physical downlink control channel (PDCCH) is used for resource allocation (the physical uplink shared channel (PUSCH) in the uplink, and the physical downlink shared channel (PDSCH) in the downlink). The PDCCH is mapped at the beginning of each frame, and the terminal device performs blind decoding (BD) thereof to identify the allocation to the terminal device itself.

Herein, the PDCCH contains a field indicating information about band allocation called the downlink control information (DCI) format. Some DCI formats are used for uplink band allocation (called format 0 or format 4), while some are used for the allocation of a contiguous downlink band (called format 1A), and some are used for the allocation of discrete bands (called format 1). Regarding downlink band allocation, multiple-input multiple-output (MIMO) transmission that transmits spatially parallel signals at the same time and the same frequency using multiple transceiving antennas (such as format 2) is also defined as a format.

In the LTE system, the length of the bits constituting each DCI format and PDCCH of the frequency band where each DCI format is mapped are specified. The method by which the terminal device detects the DCI format involves acquiring the DCI format mapped to the PDCCH, and performing multiple cyclic redundancy checks (CRCs) that detect blind decoding errors on the basis of information about the bit length of the DCI format. The terminal device is also able to detect which format was transmitted, without being separately notified of which DCI format from the base station device. For this reason, if the number of formats having different data sizes indicating band allocation information increases, the number of blind decoding attempts increases, thereby increasing the overhead required for data transmission. In current LTE systems, in order to moderate the number of blind decoding attempts, some formats of band allocation information having differences of a few bits are made to have a uniform data length by padding the differences in size, thereby moderating increases in the number of formats.

Multi-subframe scheduling (MSS; also called multi-TTI scheduling) has been proposed as a technique of improving spectral efficiency (see NPL 1). With MSS, multiple contiguous subframes are allocated. In Rel. 11 and earlier specifications, the resource that may be scheduled with one piece of control information is only one subframe. However, when using semi-persistent scheduling, a periodically available resource is allocated. For this reason, scheduling with multiple pieces of control information is required when allocating contiguous subframes, but by using MSS, contiguous subframes may be allocated with one piece of control information, thereby enabling a reduction of the amount of control information.

### CITATION LIST

### Non Patent Literature

NPL 1: Huawei, HiSilicon, “Analysis on control signaling enhancements”, R1-130892, Apr. 15-19, 2013

### SUMMARY OF INVENTION

### Technical Problem

Since the base station device is able to allocate the resources of multiple subframes to each terminal device by MSS, frame utilization efficiency is improved. However, there is a problem in that the terminal device must conduct blind decoding (an attempt to detect control information) every frame, leading to higher power consumption, which is an important factor for terminal devices.

The present invention has been devised in light of the above, and realizes a reduction in the power consumption of the terminal device by reducing the amount of computation for blind decoding that the terminal device conducts when the base station device uses MSS.

### Solution to Problem

(1) The present invention has been devised in order to solve the above problems, and an aspect of the present invention is a base station device that transmits a signal made of a frame made up of a plurality of subframes, the base station device including a PDCCH generation unit that at least generates data for indicating a resource allocation to a terminal device, and a PDSCH generation unit that at least generates data for indicating data of a higher layer, wherein the data for indicating a resource allocation at least includes data related to a number of subframes for allocating a resource of a plurality of subframes, and the data of a higher layer includes information related to a periodicity at which the data for allocating a resource of a plurality of subframes is transmitted.

(2) In addition, according to an aspect of the present invention, the information related to a periodicity at which the data for allocating a resource of a plurality of subframes is transmitted is defined independently between uplink and downlink.

(3) In addition, according to an aspect of the present invention, the information related to a periodicity at which the data for allocating a resource of a plurality of subframes is transmitted is information with respect to a terminal device-specific search space.

(4) In addition, according to an aspect of the present invention, the base station device uses a plurality of cells to transmit a signal made of a frame made up of a plurality of subframes to each of the cells, and the information related to a periodicity at which the data for allocating a resource of a plurality of subframes is transmitted is defined independently for each cell.

(5) In addition, according to an aspect of the present invention, the base station device transmits a signal that adds a cell to a terminal device that is a target of communication, and after transmitting a signal for indicating the addition of a cell, the base station device transmits, to the added cell, the information related to a periodicity at which the data for allocating a resource of a plurality of subframes is transmitted.

(6) In addition, according to an aspect of the present invention, there is provided a terminal device that receives a signal made of a frame made up of a plurality of subframes, the terminal device including a PDCCH demodulation unit that demodulates a signal in which at least a resource allocation is indicated, wherein the PDCCH demodulation unit demodulates the PDCCH at least according to a periodicity at which the PDCCH is indicated, and from the signal in which a resource allocation is indicated, at least data related to a number of subframes for allocating a resource of a plurality of subframes is demodulated.

(7) In addition, according to an aspect of the present invention, the periodicity at which the PDCCH is indicated is a predetermined value in a system in which the terminal device communicates.

(8) In addition, according to an aspect of the present invention, the terminal device additionally includes a PDSCH demodulation unit for demodulating at least data of a higher layer, and the periodicity at which the PDCCH is indicated is indicated through the data of a higher layer.

(9) In addition, according to an aspect of the present invention, the terminal device conducts communication according to a communication mode, and the periodicity at which the PDCCH is indicated is a value determined according to the communication mode.

(10) In addition, according to an aspect of the present invention, a search space in which the PDCCH is demodulated according to the periodicity at which the PDCCH is indicated is a terminal device-specific search space.

(11) In addition, according to an aspect of the present invention, there is provided a communication method performed by a base station device that transmits a signal made of a frame made up of a plurality of subframes, the communication method including a step of at least generating data for indicating a resource allocation to a terminal device, and a step of at least generating data for indicating data of a higher layer, wherein the data for indicating a resource allocation at least includes data related to a number of subframes for allocating a resource of a plurality of subframes, and the data of a higher layer includes information related to a periodicity at which the data for allocating a resource of a plurality of subframes is transmitted.

### Advantageous Effects of Invention

According to the present invention, a reduction in the power consumption of the terminal device becomes possible.

### BRIEF DESCRIPTION OF DRAWINGS

FIG. 1 is a diagram illustrating an example of a configuration of a system according to the present invention.

FIG. 2 is a diagram illustrating an example of a configuration of a base station device 101 according to the present invention.

FIG. 3 is a diagram illustrating an example of a configuration of a terminal device 102 according to the present invention.

FIG. 4 is a diagram illustrating the structure of an LTE frame.

FIG. 5 is a diagram illustrating an example of signals indicated by a higher layer from a base station device to a terminal device according to the present invention.

### DESCRIPTION OF EMBODIMENTS

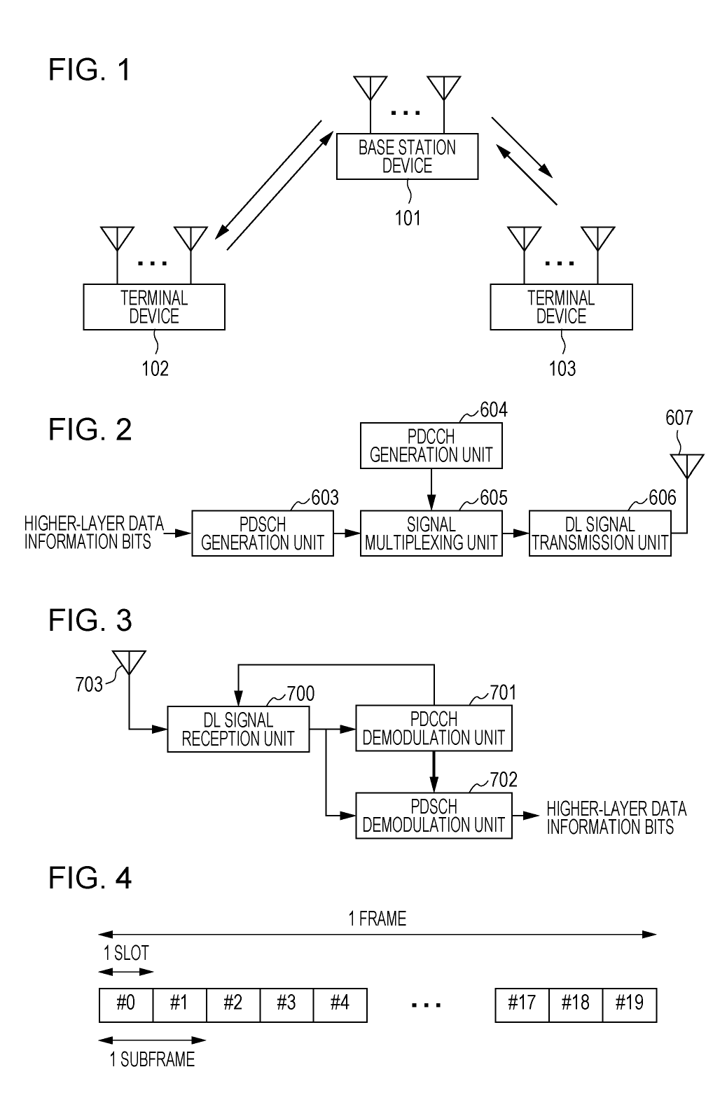

Hereinafter, an embodiment of the present invention will be described with reference to the drawings. FIG. 1 illustrates an example of a configuration of a system according to the present invention. The system is made up of a base station device 101, a terminal device 102, and a terminal device 103. Note that the number of terminal devices is not limited to two, and the number of antennas on each device may be 1. Also, although not illustrated in FIG. 1, a pico base station device (pico eNB; also called evolved Node B, SmallCell, and low power node) that transmits at a lower power than a base station device may exist within the system, and at least one terminal device may communicate with the pico base station device.

FIG. 2 illustrates an example of a configuration of a base station device 101 according to the present invention. However, a minimum of blocks required for the present invention are illustrated. A PDSCH generation unit 603 generates a signal to be transmitted in a physical channel that transmits control data indicated by a higher layer and information bits. The PDCCH generation unit 604 generates a signal to be transmitted in a physical channel that transmits downlink control information (DCI) including data controlling the physical layer, such as a control signal which is a signal for allocating radio resources, for example. Herein, the DCI is transmitted in the PDCCH in some cases, and transmitted in the enhanced PDCCH (EPDCCH) in some cases. The DCI transmitted in the PDCCH is mapped to first to fourth OFDM symbols in a subframe. Meanwhile, the DCI transmitted in the EPDCCH is mapped to multiple resource blocks. Herein, a resource block is made up of one subframe and 12 subcarriers. The signal generated by the PDCCH generation unit 604 is taken to include both the DCI transmitted in the PDCCH and the DCI transmitted in the EPDCCH. In a signal multiplexing unit 605, the PDSCH input from the PDSCH generation unit 603 and the PDCCH and EPDCCH input from the PDCCH generation unit 604 are multiplexed to form a frame structure. However, the signal multiplexing unit 605 is not strictly required to use both the PDCCH and the EPDCCH during frame construction, and may also use only one of either. The PDCCH includes a DCI that allocates transmission or reception for a terminal device.

The signal output from the signal multiplexing unit 605 is input into a DL signal transmission unit, converted into a transmit signal by the inverse fast Fourier transform (IFFT), digital-to-analog (D/A) conversion, and upconversion to a carrier frequency, and then transmitted to a terminal device via a transmit antenna 607.

FIG. 3 illustrates an example of a configuration of the terminal device 102 according to the present invention. However, a minimum of blocks required for the present invention are illustrated. Additionally, the terminal device 103 is also taken to have a similar configuration. The terminal device uses a receive antenna 703 to receive data transmitted by the base station device, and inputs the received data into a DL signal reception unit 700. The DL signal reception unit 700 downconverts the received signal to a baseband frequency, and applies analog-to-digital (A/D) conversion and the FFT. Furthermore, the DL signal reception unit 700 separates the frequency signal obtained by the FFT into PDCCH and EPDCCH signals, inputs the PDCCH and EPDCCH signals into a PDCCH demodulation unit 701, and inputs a PDSCH signal into a PDSCH demodulation unit 702. The PDCCH demodulation unit 701 demodulates the PDCCH from the input PDCCH signal sequence by performing blind decoding of a UE-specific search space (UeSS) decided on the basis of a radio network temporary identifier (RNTI), which is a user ID, and a common search space (CoSS) shared in common among connected terminal devices. The PDCCH demodulation unit 701 inputs the information of a DCI included in the demodulated PDCCH into the PDSCH demodulation unit 702. The PDSCH demodulation unit 702 demodulates control data indicated by a higher layer and information bits on the basis of the DCI information.

In addition, a technique called carrier aggregation (CA) has been adopted as of LTE-A Rel. 10. CA refers to a technique of using multiple LTE bands at the same time when multiple component carriers (CCs) which act as LTE bands exist on different frequencies. For this reason, CA is a technology that holds promise for speedup of the transmission rate, and is a technique standardized in LTE-A, which is being evaluated as the successor to LTE. LTE bands used at the same time are called component carriers, cells, or serving cells.

When communicating using CA, the terminal device communicates by using one from among the multiple cells as a primary cell. In some cases, the terminal device changes the primary cell to another cell on the basis of instructions from the base station device or the like. This process is also called handover. In a system conducting CA, a different CC may also be set as the primary cell for each terminal device. In other words, from the perspective of the base station device, which CC is the primary cell is not uniquely determined in some cases. Cells other than the primary cell are called secondary cells. Communication in a secondary cell is initiated by the terminal device being informed of information adding a cell from the primary cell or an already-connected secondary cell.

Within CA, the particular technique of using cells in different bands is called interfrequency CA (inter-CA). Different frequency bands means the case of using the 2.4 GHz band and the 5 GHz band. Also, the technique of using cells in the same band is called intrafrequency CA (intra-CA). The same frequency band refers to a technique of using cells for which the central frequency of the respective CCs is 5.2 GHz and 5.22 GHz or the like. The case of inter-CA requires multiple processing circuits, including RF circuits, in the terminal device, but for intra-CA, processing is possible with a single RF circuit. When conducting CA, the base station device simply physically or logically includes the PDCCH generation unit 604 and the PDSCH generation unit 603 discussed earlier for each cell. In addition, a DL signal transmission unit 606 may be included for each cell in some cases, or a configuration shared in common among multiple cells may be taken.

### First Embodiment

The present embodiment is illustrated for a case in which the interval of transmitting the PDCCH or the EPDCCH is quasi-statically or statically indicated by a higher layer, and how many subframes are allocated as resources is transmitted by a DCI included in the PDCCH or the EPDCCH. In addition, a case is also envisioned in which values determined by the system are used without an indication when static parameters are used. Furthermore, the present embodiment is also effective in a case in which a higher layer indicates how many subframes are allocated as resources.

FIG. 4 is a diagram illustrating the structure of an LTE frame. The present embodiment describes a case in which 1 frame is made up of 10 subframes, and 1 subframe is made up of 2 slots. In addition, the structure allows for the PDCCH to be included in each subframe. Additionally, the structure allows for the enhanced PDCCH (EPDCCH) to be introduced for efficient DCI transmission, and the EPDCCH may also be included in each subframe. However, in the case of using MSS, frames in which either or both of the PDCCH and the EPDCCH do not exist are possible. In addition, the PDCCH and the EPDCCH include a DCI that performs downlink resource allocation, and a DCI that performs uplink allocation. As discussed earlier, information about the resource allocation of how many subframes is included in the DCI, but a case of a variable number of such frames is envisioned. In the non-variable case, the number of frames may be fixed by the system or indicated by a higher layer as a quasi-static parameter, but such a case is also included in the invention of the present embodiment.

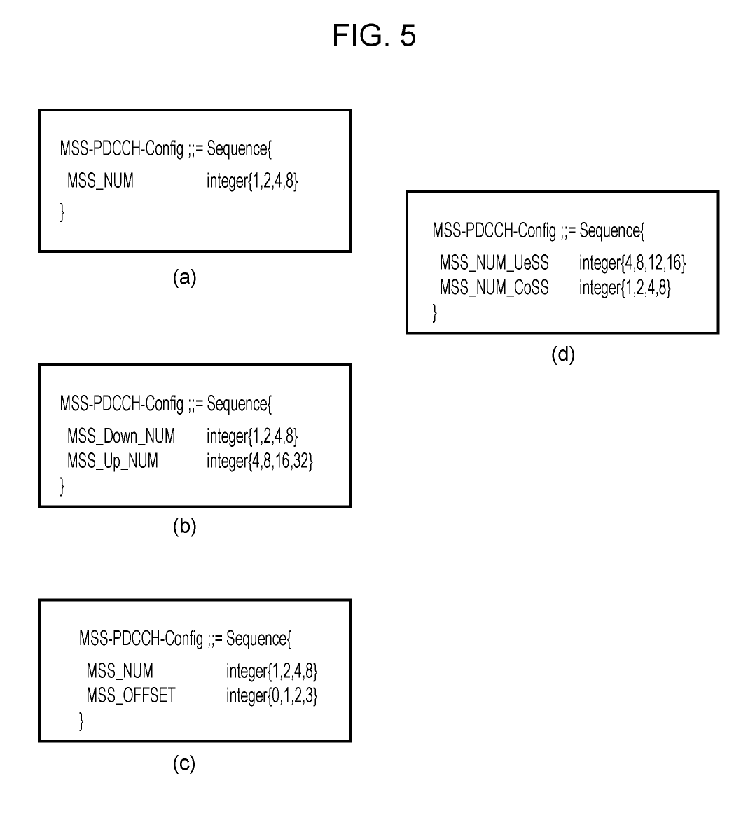

FIG. 5(a) illustrates an example of signals indicated by a higher layer from a base station device to a terminal device according to the present invention. This is an example of a communication method, and is an example of indicating to each terminal device through a higher layer. Additionally, in the case of treating the information as information shared in common among all terminal devices, this example may be considered to be a method of indicating by broadcast. Indicating to each terminal device enables flexible subframe configuration, while the case of indicating by broadcast has the merit of not increasing the control information very much. MSS_NUM illustrated in the drawing is a parameter indicating the subframe interval at which to transmit the PDCCH indicated to a terminal device. Consequently, it is sufficient for each terminal device to attempt blind decoding of the PDCCH on the subframe interval (periodicity) of MSS_NUM, thereby enabling a reduction in power consumption. In the system employing the drawings, the base station device selects one specific subframe interval at which to transmit the PDCCH from among {1, 2, 4, 8}, and indicates the interval to the terminal device. Since 1 subframe is 1 ms, if the base station device indicates that MSS_NUM is 4, blind decoding is conducted with a periodicity of 4 ms.

FIG. 5(b) illustrates a method of indicating parameters when changing MSS_NUM on the uplink and the downlink according to the present invention. For the terminal device, ordinarily MS_NUM_UP indicates, for each subframe, the subframe interval at which the PDCCH including an uplink resource allocation, while MSS_NUM_DOWN indicates the subframe interval at which the PDCCH including a downlink resource allocation. Until now, the terminal device has been required to conduct blind decoding of the uplink PDCCH and the downlink PDCCH for 1 subframe. By using this technique, the base station device is able to set a subframe in which the terminal device conducting blind decoding of only one of the uplink and the downlink is sufficient. Particularly when the amount of data between the uplink and the downlink is disproportionate, it becomes possible to better fit the number of times blind decoding is conducted. For example, when 4 is selected as the subframe interval at which to transmit the PDCCH for downlink resource allocation, and 16 is the subframe interval at which to transmit the PDCCH for uplink resource allocation, it is sufficient to conduct blind decoding for uplink resource allocation at ¼ the interval of the number of times to conduct blind decoding to the downlink PDCCH, thus making it possible to further reduce power consumption compared to the case of FIG. 5(a). Although a case in which the selectable parameters are different is illustrated herein, similar advantageous effects may be obtained by individually selecting parameters, even if the selection options are the same. Also, as in FIG. 5(b), when the parameter selection options are made to be different, if one uses a parameter so as to be a common multiple of the other, the blind decoding that detects the uplink and the downlink resource allocation becomes the same subframes, and power consumption may be reduced.

Furthermore, FIG. 5(c) illustrates an example of indicating parameters for changing the subframes in which to conduct blind decoding for each terminal device according to the present invention. Herein, MSS_OFFSET indicates the offset value of the subframe in which to transmit the PDCCH. For example, the case of MSS_NUM=4 and MSS_OFFSET=1 means that the PDCCH is transmitted in the subframe with the subframe number 4×N+1 (where N is an integer). Consequently, it becomes possible to change the subframe in which to transmit the PDCCH for each terminal device, and it becomes possible to avoid the PDCCH becoming concentrated in a certain subframe. Next, operation of a terminal device in the case of indicating MSS-related information using the parameters in FIG. 5(c) will be described. In the following description, suppose that MSS_NUM=8, MSS_OFFSET=0, and the number of subframes specified by the DCI is 4.

The terminal device to which such parameters are indicated conducts blind decoding of the PDCCH in the subframe numbers 0, 8, and 16 in FIG. 4. Subsequently, when there is a DCI in the downlink addressed to the terminal device itself, the terminal device conducts demodulation under the assumption that data addressed to itself exists in the subframes with the subframe numbers from 0 to 3. In addition, when there is a DCI in the uplink addressed to the terminal device itself, the terminal device conducts data transmission in the subframes with the subframe numbers from 4 to 7. Compared to a system in which either or both of the PDCCH and the EPDCCH are expected to exist in each subframe like in the related art, the number of times blind decoding is conducted becomes ⅛ in the downlink example discussed above, while in addition, downlink operations become unnecessary for the subframe numbers from 4 to 7, which greatly contributes to reduced power consumption.

Note that although the present embodiment describes a common subframe interval at which the PDCCH and the EPDCCH are transmitted, a subframe interval may also be configured for each of the PDCCH and the EPDCCH. In addition, the subframe interval at which the PDCCH and the EPDCCH are transmitted may also be treated as a parameter shared in common inside the cell. In this case, the RE of the PDCCH and the EPDCCH may be used for transmission of the PDSCH, and the spectral efficiency may be improved.

In the description of the present embodiment as above, the subframe interval at which to transmit the DCI in the PDCCH and the EPDCCH is indicated as a quasi-static parameter by a higher layer, thereby reducing the number of times blind decoding is conducted by the terminal device, and contributing to reduced power consumption.

### Second Embodiment

When the terminal device demodulates the DCI, in LTE a UE-specific search space (UeSS) and a search space shared in common among the connected terminal devices (called the CoSS) are defined. For the UeSS, a search space decided on the basis of the RNTI unique to each terminal device is decided. For this reason, the position of the UeSS in which to conduct blind decoding is different for each terminal device. For the CoSS, the position at which to conduct blind decoding of the search space shared in common among all terminal devices is predetermined. Limiting the position in this way contributes to a reduction in the number of times that blind decoding is conducted.

In the case of changing all DCI timings like in Embodiment 1, if signals are exchanged like in FIG. 5(a), the UeSS and the CoSS both may be processed on the same interval. Additionally, in the case of configuring the subframe interval at which to transmit the PDCCH related to the UeSS only, it is sufficient to similarly apply the signal of FIG. 5(a) to the UeSS. In the case of configuring parameters for the UeSS and the CoSS, it is necessary to indicate, from the base station device to the terminal device, a signal enabling the configuration of the respective parameters. FIG. 5(d) illustrates a signal in the case of configuring a different indication interval for the UeSS and the CoSS according to the present invention. In this example, MSS_NUM_UeSS represents the transmit interval of the UeSS, which may be selected from {4, 8, 12, 16}. Also, MSS_NUM_CoSS represents the transmit interval of the CoSS, which may be selected from {1, 2, 4, 8}. In this way, the subframe interval at which to conduct blind decoding of at least either DCI may be lengthened, thereby contributing to reduced power consumption of the terminal device.

In the description of the present embodiment as above, the subframe interval at which to transmit the DCI in the PDCCH and the EPDCCH is indicated as a quasi-static parameter by a higher layer for the UeSS and the CoSS, respectively, thereby reducing the number of times blind decoding is conducted by the terminal device, and contributing to reduced power consumption.

### Third Embodiment

In the present embodiment, the configuration of the MSS in the case of conducting carrier aggregation (CA) will be illustrated.

In the case of performing MSS in a system conducting CA, a method of indicating the parameters of FIG. 5 to each cell (each serving cell) illustrated in Embodiment 1 is conceivable. This method is particularly effective for inter-CA. For example, since a cell with a good communication status (a cell with a low frequency band) is likely to have many terminal devices connected, the subframe interval at which to transmit the PDCCH may be shortened to increase allocation opportunities to each terminal device, whereas for another kind of cell, the subframe interval at which to allocate the PDCCH may be lengthened, which is effective when raising the data transmission efficiency. In addition, since the primary cell and secondary cells may be differentiated for the terminal device, it becomes possible for different processing circuits in the terminal device to perform separate processes. Thus, in the primary cell, a continuous connection with the base station device may be maintained, while in the secondary cell, efficient communication with reduced power consumption as illustrated in Embodiment 1 becomes possible.

From the perspective of blind decoding by the terminal device, power consumption is more efficiently reduced by having the PDCCH which must be blind decoded by all cells in the CA system exist in the same subframe. Thus, to make this state the default, when adding a secondary cell, a method of using the parameters of the primary cell by default as the MSS-related parameters is conceivable. According to such a method, parameters may be configured without adding new information. However, if information related to a change of parameter configuration (reconfiguration) flows down after the addition of a secondary cell, if the MSS parameters are made to be modifiable, the merit of being able to change the MSS parameters may also be enjoyed.

Next, the case of conducting cross-carrier scheduling will be illustrated. Cross-carrier scheduling refers to scheduling when allocating resources of a first cell, in which the scheduling is performed in the PDCCH of a different cell from the first cell. In this case, if the parameters to use are not decided in advance, the terminal device is unable to operate as intended by the base station device. One method of resolving the above is to make each parameter of MSS use the parameters of the cell in which the PDCCH is transmitted. For example, the number of subframes which may be scheduled consecutively by MSS is fixed for each cell, and the case in which a different value is configured for each cell means that the number of subframes in the cell in which the PDCCH is received is used.

Similarly, each parameter of MSS may also use the parameters of the actually scheduled cell. For example, the number of subframes which may be scheduled consecutively by MSS is fixed for each cell, and the case in which a different value is configured for each cell means that the number of subframes in the actually scheduled cell is used.

### Fourth Embodiment

In Embodiments 1 to 3, a case is illustrated in which from the perspective of the terminal device, at least information related to the subframe periodicity of the PDCCH for transmitting MSS and information related to the number of subframes in which to actually demodulate the PDSCH are indicated by different methods. The present embodiment describes a case in which both pieces of information are indicated by the DCI included in the PDCCH.

In a system of the related art, ordinarily, the terminal device is presumed to decode the PDCCH in all subframes, and thus the terminal device wastes power by demodulating the PDCCH even when there is no DCI addressed to the terminal device itself. Accordingly, if transmit subframe interval information up to the next PDCCH is defined in the DCI, the terminal device is not required to conduct blind decoding on a fixed interval of subframes, and is thereby able to reduce power consumption. Specifically, it is sufficient to prepare several bits with which to indicate the subframe interval and the like up to the transmission of the next PDCCH.

Alternatively, in the case in which information related to the periodicity of subframes at which to transmit the PDCCH is indicated or the like according to another method as illustrated in Embodiments 1 to 3, a conceivable method is to prepare a single bit, and enable the subframe periodicity indicated by the another method or the like when the bit is enabled, and conduct blind decoding of the PDCCH like normal when the bit is disabled. According to this method, the base station device is able to adaptively control the subframe interval at which to transmit the PDCCH, and thus efficient system management may be realized while also reducing power consumption in the terminal device.

Furthermore, the above DCI may also be defined for each search space. In this method, the subframe interval information in the DCI indicated in the CoSS is valid only in the CoSS, while the subframe interval information indicated in the UeSS is valid only in the CoSS. In addition, with CA using multiple CCs, a method making the information valid for each CC or a method making the subframe interval information indicated in a single CC valid for all CCs is conceivable. For example, the subframe interval indicated in the primary cell is also applied to a secondary cell. The advantageous effects are similar to those illustrated in Embodiment 3, and are effective for inter-CA and intra-CA, respectively.

### Fifth Eembodiment

In the case of using MSS, a method of configuring the communication mode is also conceivable. The communication mode refers to a method of configuring a mode according to a communication scheme, such as a mode that communicates by SU-MIMO or a mode that communicates by MU-MIMO, and by demodulating only the PDCCH associated with the mode, the number of times blind decoding is conduct may be reduced. Such a method is already implemented in LTE Rel. 8.

An MSS mode is provided in addition to the above, and a terminal device for which MSS mode is specified decodes the PDCCH in a predetermined, designated subframe interval. According to this method, if the subframe interval and the like at which to transmit the PDCCH is fixed, the exchange of control data is no longer necessary. Additionally, it is also possible to provide multiple MSS modes, and make the subframe interval and the like at which to transmit the DCI in the PDCCH semi-fixed (treated as a value dependent on each MSS mode). In addition, a method of performing the methods of Embodiments 1 to 4 in addition to providing an MSS mode is also conceivable.

The present embodiment illustrates a merit of being able to reduce the number of times blind decoding is conducted, but if the PDCCH transmit subframe could be aligned for all terminal devices, it would be possible to construct a subframe for which the PDCCH does not need to be transmitted, thereby producing a merit of improving the communication efficiency of the system overall.

In addition, all of the embodiments describe a subframe interval at which to transmit the PDCCH, but are also applicable to a control signal for reserving resources. For example, the EPDCCH being considered for LTE systems is such an example. One difference between the EPDCCH and the PDCCH is that whereas the transmit timing and the like of the PDCCH is limited (for example, the first to fourth OFDM symbols from the beginning of a subframe), the EPDCCH does not have such limitations.

A program operating on a base station device and a terminal device according to the present invention is a program that controls a CPU or the like (a program that causes a computer to function) so as to realize the functions of the foregoing embodiments according to the present invention. Additionally, information handled by these devices is temporarily buffered in RAM during the processing thereof, and thereafter stored in various types of ROM or an HDD, read out, and modified/written by the CPU as necessary. A recording medium that stores the program may be any of a semiconductor medium (such as ROM or a non-volatile memory card, for example), an optical recording medium (such as a DVD, MO, MD, CD, or BD, for example), or a magnetic recording medium (such as magnetic tape or a flexible disk, for example). Also, rather than the functions of the embodiment discussed above being realized by executing a loaded program, in some cases the functions of the present invention may be realized by joint processing with an operating system, another application program, or the like.

Also, in the case of distribution into the market, the program may be distributed such as by being stored on a portable recording medium, or by being transferred to a server computer connected via a network such as the Internet. In this case, a storage device of the server computer is also included in the present invention. In addition, all or part of the base station device and the terminal device in the foregoing embodiments may also be realized as LSI, which is typically an integrated circuit. The various function blocks of the base station device and the terminal device may be realized as individual chips, or all or part thereof may be integrated as a single chip. Furthermore, the circuit integration methodology is not limited to embedded systems and may be also be realized with special-purpose circuits, or with general-purpose processors. When respective function blocks are integrated into an integrated circuit, an integrated circuit controller that controls the respective function blocks is additionally provided.

Furthermore, the circuit integration methodology is not limited to embedded systems and may be also be realized with special-purpose circuits, or with general-purpose processors. In addition, if progress in semiconductor technology yields integrated circuit technology that may substitute for LSI, the use of an integrated circuit according to that technology is also possible.

Also, the present invention is not limited to the foregoing embodiments. A terminal device of the present invention is not limited to application to a mobile station device, and obviously may also be applied to stationary or non-mobile electronic equipment installed indoors or outdoors, such as AV equipment, kitchen appliances, cleaning and laundry equipment, air conditioning equipment, office equipment, vending machines, and other consumer equipment, for example.

The foregoing thus describes an embodiment of the present invention in detail and with reference to the drawings. However, specific configurations are not limited to this embodiment, and design modifications or the like within a scope that does not depart from the spirit of the present invention are to be included. Furthermore, various modifications of the present invention are possible within the scope indicated by the claims. Embodiments obtained by appropriately combining the technical means respectively disclosed in different embodiments are also included within the technical scope of the present invention. Additionally, configurations in which elements described in the foregoing embodiments and exhibiting similar advantageous effects are substituted with each other are also to be included.

### REFERENCE SIGNS LIST

101 base station device

102 terminal device

103 terminal device

603 PDSCH generation unit

604 PDCCH generation unit

605 signal multiplexing unit

606 DL signal transmission unit

607 transmit antenna

703 receive antenna

700 DL signal reception unit

701 PDCCH demodulation unit

706 PDSCH demodulation unit

1. A base station device that transmits a signal made of a frame made up of a plurality of subframes, the base station device comprising:
a PDCCH generation unit that at least generates data for indicating a resource allocation to a terminal device; and
a PDSCH generation unit that at least generates data for indicating data of a higher layer, wherein
the data for indicating a resource allocation at least includes data related to a number of subframes for allocating a resource of a plurality of subframes, and
the data of a higher layer includes information related to a periodicity at which the data for allocating a resource of a plurality of subframes is transmitted.

2. The base station device according to claim 1, wherein
the information related to a periodicity at which the data for allocating a resource of a plurality of subframes is transmitted is defined independently between uplink and downlink.

3. The base station device according to claim 1, wherein
the information related to a periodicity at which the data for allocating a resource of a plurality of subframes is transmitted is information with respect to a terminal device-specific search space.

4. The base station device according to claim 1, wherein
the base station device uses a plurality of cells to transmit a signal made of a frame made up of a plurality of subframes to each of the cells, and
the information related to a periodicity at which the data for allocating a resource of a plurality of subframes is transmitted is defined independently for each cell.

5. The base station device according to claim 3, wherein
the base station device transmits a signal that adds a cell to a terminal device that is a target of communication, and
after transmitting a signal for indicating the addition of a cell, the base station device transmits, to the added cell, the information related to a periodicity at which the data for allocating a resource of a plurality of subframes is transmitted.

6. A terminal device that receives a signal made of a frame made up of a plurality of subframes, the terminal device comprising:
a PDCCH demodulation unit that demodulates a signal in which at least a resource allocation is indicated, wherein
the PDCCH demodulation unit demodulates the PDCCH at least according to a periodicity at which the PDCCH is indicated, and
from the signal in which a resource allocation is indicated, at least data related to a number of subframes for allocating a resource of a plurality of subframes is demodulated.

7. The terminal device according to claim 6, wherein
the periodicity at which the PDCCH is indicated is a predetermined value in a system in which the terminal device communicates.

8. The terminal device according to claim 6, wherein
the terminal device additionally includes a PDSCH demodulation unit for demodulating at least data of a higher layer, and
the periodicity at which the PDCCH is indicated is indicated through the data of a higher layer.

9. The terminal device according to claim 6, wherein
the terminal device conducts communication according to a communication mode, and
the periodicity at which the PDCCH is indicated is a value determined according to the communication mode.

10. The terminal device according to claim 6, wherein
a search space in which the PDCCH is demodulated according to the periodicity at which the PDCCH is indicated is a terminal device-specific search space.

11. A communication method performed by a base station device that transmits a signal made of a frame made up of a plurality of subframes, the communication method comprising:
a step of at least generating data for indicating a resource allocation to a terminal device; and
a step of at least generating data for indicating data of a higher layer, wherein
the data for indicating a resource allocation at least includes data related to a number of subframes for allocating a resource of a plurality of subframes, and
the data of a higher layer includes information related to a periodicity at which the data for allocating a resource of a plurality of subframes is transmitted.
